(19) United States
(12) Patent Application Publication
(10) Pub. No.: US 2024/0430988 A1
(43) Pub. Date: Dec. 26, 2024

(54) PLANAR HEATER AND HUMIDIFYING APPARATUS HAVING THE SAME

(71) Applicant: SAMSUNG ELECTRONICS CO., LTD., Suwon-si (KR)

(72) Inventors: Minkyung LEE, Suwon-si (KR); Soobin KWON, Suwon-si (KR); Kwangjoo KIM, Suwon-si (KR); Sungmin CHO, Suwon-si (KR); Minsu KANG, Suwon-si (KR); Junhan BAE, Suwon-si (KR); Hyunseok SHIN, Suwon-si (KR); Youngdeog KOH, Suwon-si (KR); Hoon WEE, Suwon-si (KR)

(73) Assignee: SAMSUNG ELECTRONICS CO., LTD., Suwon-si (KR)

(21) Appl. No.: 18/769,871

(22) Filed: Jul. 11, 2024

Related U.S. Application Data
(63) Continuation of application No. PCT/KR2024/007845, filed on Jun. 10, 2024.

(30) Foreign Application Priority Data
Jun. 20, 2023 (KR) 10-2023-0079312
Sep. 12, 2023 (KR) 10-2023-0121308
Apr. 12, 2024 (KR) 10-2024-0049656

(51) Int. Cl. H05B 3/26; H05B 3/14

(52) U.S. Cl. CPC H05B 3/26; H05B 3/141

(57) ABSTRACT

A humidifying apparatus can include a water tank, and a duct through which water vapor generated in the water tank flows, wherein the water tank includes a bottom plate generating heat, the bottom plate includes a first glass plate disposed within the water tank and a second glass plate disposed below the first glass plate and spaced apart from the first glass plate, and the first glass plate includes a heating layer coated on a lower surface of the first glass plate, and the second glass plate includes a low emissivity layer coated on an upper surface of the second glass plate to suppress heat generated in the heating layer from being transferred to the outside of the second glass plate.

### CROSS-REFERENCE TO RELATED APPLICATIONS

This is a continuation application, under 35 U.S.C. § 111 (a), of International Application No. PCT/KR2024/007845, filed Jun. 10, 2024, which claims priority under 35 U.S.C. § 119 to Korean Patent Application No. 10-2023-0079312, filed Jun. 20, 2023, Korean Patent Application No. 10-2023-0121308, filed Sep. 12, 2023, and Korean Patent Application No. 10-2024-0049656, filed Apr. 12, 2024 in the Korean Intellectual Property Office, the disclosures of which are incorporated herein in their entireties by reference.

### TECHNICAL FIELD

The disclosure relates to a planar heater having an improved structure and a humidifying apparatus having the same.

### BACKGROUND ART

In general, humidifying devices are devices that regulate the humidity in a room by evaporating water. The humidifying devices are used to keep the humidity in the room at an appropriate level and to prevent various respiratory diseases.

For example, humidifying devices may include ultrasonic humidifying device that use ultrasound to evaporate water, heated humidifying devices that heat and evaporate water, and an evaporative humidifying devices that humidify water through natural evaporation.

In the case of a heated humidifying device, when heating water, only a portion of the water contained in an entire water tank is heated, which reduces the heating efficiency of the water in the entire water tank, and noise may be generated from a heating element due to the high heat density of the heating element.

### SUMMARY

One aspect of the present disclosure provides a planar heater having improved heat transfer efficiency by improving the direction of heat transfer.

One aspect of the present disclosure provides a humidifying apparatus with improved heating efficiency of water in a tank.

One aspect of the present disclosure provides a humidifying apparatus with reduced noise.

Technical tasks to be achieved in this document are not limited to the technical tasks mentioned above, and other technical tasks not mentioned will be clearly understood by those skilled in the art from the description below.

A humidifying apparatus according to the spirit of the present disclosure may include a water tank, and a duct through which water vapor generated in the water tank flows, wherein the water tank includes a bottom plate including a first glass plate disposed within the water tank and a second glass plate disposed below the first glass plate and spaced apart from the first glass plate, the first glass plate includes a heating layer coated on a lower surface of the first glass plate and configured to generate heat, and the second glass plate includes a low emissivity layer coated on an upper surface of the second glass plate to suppress heat generated in the heating layer from being transferred to an outside of the second glass plate.

The bottom plate may further include a sealing member to seal a space between the first glass plate and the second glass plate from the outside.

The bottom plate may further include a gap space formed by the first glass plate, the second glass plate, and the sealing member.

The heating layer may include a graphene material.

The heating apparatus may further include a cover layer covering the heating layer.

The cover layer may include a silicone material.

The first glass plate may form a bottom interior surface of the water tank.

The first glass plate may further include at least one electrode electrically connected to the heating layer, and the at least one electrode may be sealed by the sealing member.

The at least one electrode may include a first electrode and a second electrode formed at opposite ends of the heating layer, respectively, along a longest side of the heating layer.

The gap space may contain an inert gas.

The first glass plate and the second glass plate each may include a polyimide film material.

The heating layer may be patterned on the lower surface of the first glass plate.

The heating layer may be patterned on the lower surface of the first glass plate, and the cover layer may be configured to cover a region of the lower surface which may be exposed by the patterned heating layer.

The lower surface of the first glass plate may be patterned, and the heating layer may be attached to an entirety of the patterned lower surface.

A humidifying apparatus according to the spirit of the present disclosure may include a water tank, and a duct through which water vapor generated in the water tank flows, wherein the water tank includes a body, and a planar heater forming a bottom of the body, the planar heater includes a first glass plate forming at least a portion of a bottom of the water tank and having a heating layer configured to generate heat, a second glass plate disposed below the first glass plate and spaced apart from the first glass plate, and a sealing member configured to seal a space between the first glass plate and the second glass plate from an outside, and the second glass plate includes a low emissivity layer coated on an upper surface of the second glass plate to suppress heat generated in the heating layer from being transferred to the outside of the second glass plate.

The heating layer may be coated on a lower surface of the first glass plate.

The planar heater may further include a gap space formed by the first glass plate, the second glass plate, and the sealing member.

The heating layer may include a graphene material.

The first glass plate may further include a cover layer covering the heating layer.

A planar heater according to the spirit of the present disclosure may include a first glass plate, a second glass plate disposed below the first glass plate and spaced apart from the first glass plate, a sealing member to seal a space between the first glass plate and the second glass plate from an outside; and a gap space formed by the first glass plate, the second glass plate, and the sealing member, wherein the first glass plate includes a heating layer coated on a lower surface of the first glass plate, and the second glass plate includes a low emissivity layer coated on an upper surface of the second glass plate to suppress heat generated in the heating layer from being transferred to the outside of the second glass plate.

### DESCRIPTION OF DRAWINGS

FIG. 1 is a perspective view showing a humidifying apparatus according to an embodiment of the present disclosure.

FIG. 2 is an interior view showing the humidifying apparatus according to an embodiment of the present disclosure.

FIG. 3 is a view of a water tank of the humidifying apparatus according to an embodiment of the present disclosure as the water tank is withdrawn from the humidifying apparatus.

FIG. 4 is a schematic view showing a cross-section of a planar heater of the humidifying apparatus according to an embodiment of the present disclosure.

FIG. 5 is a schematic view showing a plane of a partial structure of the planar heater of the humidifying apparatus according to an embodiment of the present disclosure.

FIG. 6 is a schematic view showing a plane of a portion of the structure of the planar heater of the humidifying apparatus according to an embodiment of the present disclosure.

FIG. 7 is a schematic view showing a cross-section of a lower portion of the water tank of the humidifying apparatus according to an embodiment of the present disclosure.

FIG. 8 is a schematic view showing a cross-section of the lower portion of the water tank of the humidifying apparatus according to an embodiment of the present disclosure.

FIG. 9 is a schematic view showing a cross-section view of the lower portion of the water tank of the humidifying apparatus according to an embodiment of the present disclosure.

### MODES OF THE INVENTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

Terms such as “1st”, “2nd”, “first”, or “second” may be used simply to distinguish a component from other components, without limiting the component in other aspects (e.g., importance or order).

When a component (e.g., a first component) is referred to as “coupled” or “connected” to another component (e.g., a second component), with or without the terms “functionally” or “communicatively,” it may refer to that the component may be connected to another component directly (e.g., wired), wirelessly, or through a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” or “over” another component, it can be directly on the other component or intervening components may also be present.

Furthermore, as used in the disclosure, the terms “front”, “rear”, “top”, “bottom”, “side”, “left”, “right”, “upper”, “lower”, and the like are defined with reference to the drawings, and are not intended to limit the shape and position of each component.

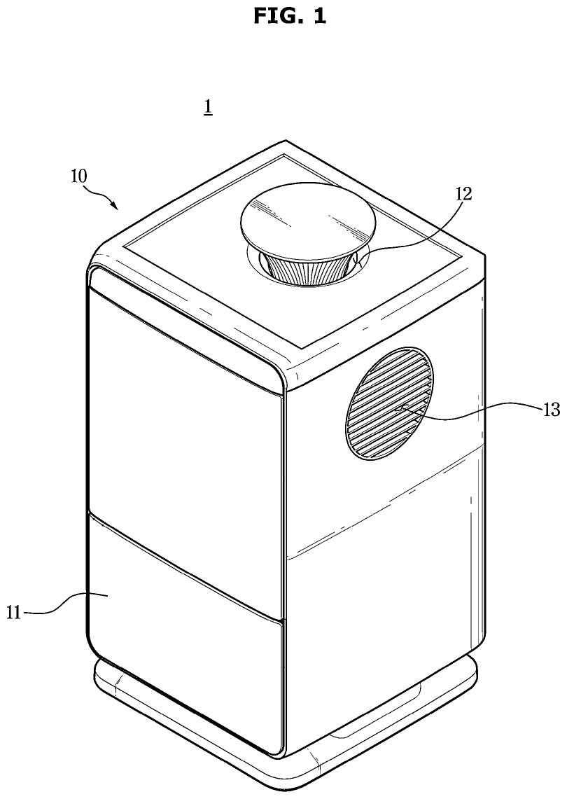

For example, with reference to FIG. 1, a direction in which a front surface of a humidifying apparatus 1 faces may be defined as a front, and the opposite direction may be defined as a rear. Also, for example, both sides of the humidifying apparatus 1 with respect to FIG. 1 may be referred to as a left-to-right direction, and up and down directions of the humidifying apparatus 1 with respect to FIG. 1 may be referred to as a vertical direction. However, these references are for ease of description only and are not limited to the drawings.

Hereinafter, various embodiments according to the disclosure will be described in detail with reference to the accompanying drawings.

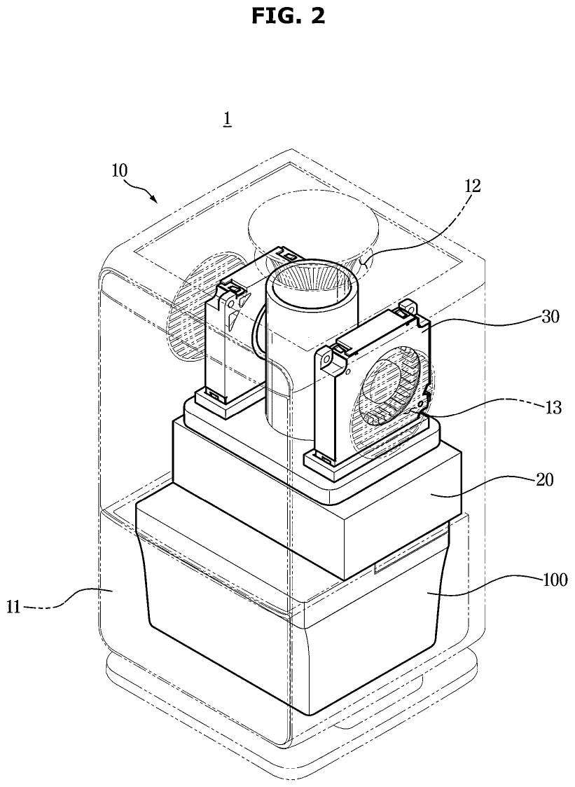

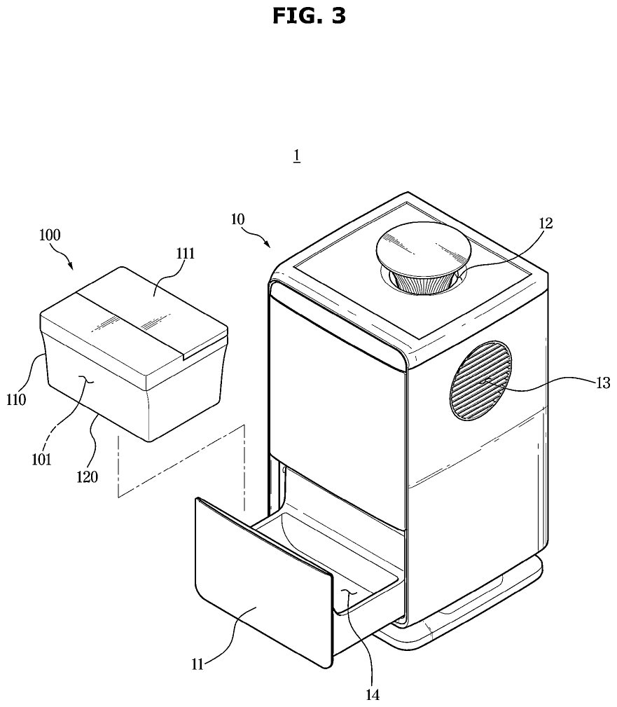

FIG. 1 is a perspective view showing a humidifying apparatus according to an embodiment, FIG. 2 is a view showing the interior of the humidifying apparatus according to an embodiment, and FIG. 3 is a view showing a water tank of the humidifying apparatus according to an embodiment being withdrawn from the humidifying apparatus.

Referring to FIGS. 1 to 3, a humidifying apparatus 1 (also referred to as humidification apparatus) may include a main body 10 forming the exterior thereof, a drawer 11 detachably coupled to the main body 10, and a water tank 100 accommodated in the drawer 11. The drawer 11 may be pulled out of the main body 10, and may be provided to be pulled back into the main body 10 again from the pulled-out state.

In an example, the drawer 11 may be slidably coupled to the main body 10.

In an example, a user may grip the drawer 11, apply an external force to cause the drawer 11 to slide from the main body 10, and withdraw the water tank 100 accommodated in the drawer 11 from the main body 10.

In an example, the humidifying apparatus 1 may include an automatic actuation device arranged to cause the drawer 11 to slide automatically. The automatic actuation device may apply an external force to the drawer 11 such that the drawer 11 slides away from the main body 10 or is retracted into the main body 10 based on a user input or a signal from a controller.

In an example, a water tank receiving portion 14 may be formed inside the drawer 11. In an example, the water tank receiving portion 14 may be connected to a power supply portion in which the water tank 100 is settled and which is connected to electrodes 123 of a planar heater 120 (also referred to as a surface heating element), which will be described later.

In an example, the power supply portion may include a printed circuit board (PCB) or the like that is electrically connected to the planar heater 120 and is arranged to supply power to the planar heater and control the planar heater.

In an example, the power supply portion may be located at a lower portion of the water tank receiving portion 14. In an example, the power supply portion may be located at a rear side of the water tank receiving portion 14.

In an example, the main body 10 may not include the drawer 11 and may be arranged for the user to withdraw the water tank 100 from the main body 10 by pressing on the water tank 100 itself. In an example, at least a portion of the water tank 100 may be arranged to be exposed externally of the main body 10, and thus the user may grip the externally exposed water tank 100 to withdraw the water tank 100 from the main body 10. In an example, the main body 10 may include a receiving cavity in which the water tank 100 is received, and the receiving cavity may be arranged to be connected to the water tank receiving portion 14. In an example, the water tank receiving portion 14 may be exposed to the outside through the receiving cavity, and the water tank 100 received in the water tank receiving portion 14 may be exposed to the outside through the receiving cavity. In an example, the water tank 100 may be slidably coupled to the main body 10. The water tank 100 may be slidably moved away from the main body 10 or be retracted into the main body 10.

In an example, the humidifying apparatus 1 may include an automatic actuation device that allows the water tank 100 to automatically slide. The automatic actuation device may apply an external force to the water tank 100 such that the water tank 100 slides away from the main body 10 or is retracted into the main body 10 based on a user input or a signal from the controller.

The water tank 100 may be arranged to receive water.

In an example, the water tank 100 may allow the user to supply water to the interior of the water tank 100 by withdrawing the water tank 100 from the main body 10.

In an example, the water tank 100 may include a supply port and the humidifying apparatus may include a supply pump connected to the supply port, so that the water tank 100 may be supplied with water without being withdrawn from the main body 10.

The humidifying apparatus 1 may include a duct 20 arranged to discharge water vapor generated in the water tank 100.

The main body 10 may include an outlet 12 through which water vapor generated in the water tank 100 is discharged to the outside of the humidifying apparatus 1 through the duct 20.

In an example, the outlet 12 may be arranged to communicate with one end of the duct 20, and the water tank 100 may be arranged to communicate with the other end of the duct 20.

In an example, the outlet 12 may be located at an upper portion of the main body 10. In an example, the outlet 12 may be positioned at a front or side portion of the main body 10.

The humidifying apparatus 10 may further include a fan assembly 30.

The fan assembly 30 may be arranged to draw in air from the outside and flow the air into the humidifying apparatus 1. The fan assembly 30 may provide outside air into the interior of the humidifying apparatus 1. In an example, the fan assembly 30 may be arranged to be in communication with the duct 20 and may flow outside air through the duct 20.

In one example, the fan assembly 30 may be provided in a plurality. In FIG. 2, two fan assemblies 30 are shown, but the present disclosure is not limited thereto and may be provided with three or more. Alternatively, the fan assembly 30 may be provided as a single fan assembly.

The main body 10 may include an inlet 13 that allows air to be drawn into the main body 10 by the fan assembly 30. A position of the inlet 13 may be arranged to correspond to a position of the fan assembly 30. For example, the positions of the fan assembly 30 and the inlet 13 may be not limited thereto.

The water tank 100 may include a body 110 that forms an interior 101 of the water tank 100. For example, the body 110 may include an opening 111 that opens the interior 101 of the water tank 100 to allow the user to supply water.

In an example, the opening 111 may be provided in the form of a door. In an example, the opening 111 may be provided in the form of a hole and may be opened or closed by a cap or the like. In an example, the opening 111 may be provided in the form of a hole without a cover.

In an example, when the water tank 100 includes the supply port, the water tank 100 may eliminate the opening 111.

In an example, when the water tank 100 is accommodated in the main body 10 after being accommodated in the water tank receiving portion 14, the opening 111 may be arranged to be in communication with the duct 20.

In an example, when the water tank 100 is connected to the duct 20, the opening 111 may be arranged such that a component such as a door forming the opening 111 is opened.

In an example, the opening 111 may be arranged to be opened by a guide that guides opening of a component such as a door or the like forming the opening 111 within the main body 10. In an example, the opening 111 may be arranged to be opened by an opening device that opens a component such as a door or the like forming the opening 111 from inside the main body 10.

The water tank 100 may be provided in a substantially box shape. The body 110 may be provided in a box shape with a bottom.

In an example, the body 110 may be provided in a cylindrical shape with a circular bottom.

In an example, the body 110 may be made of a material that is transparent enough to allow the user to identify from the outside an amount of water remaining in the interior 101 of the water tank 100.

The water tank 100 may include the planar heater 120 that heats the water received in the interior 101 of the water tank 100. The planar heater 120 may generate water vapor by heating the water contained in the water tank 100.

In an example, the planar heater 120 may be arranged to heat water accommodated in the interior 101 of the water tank 100. In an example, the planar heater 120 may be arranged to boil the water contained in the water tank 100.

In an example, the planar heater 120 may form at least a portion of the body 110.

In an example, the planar heater 120 may be formed on at least a partial area of the body 110.

In an example, the planar heater 120 may form a bottom of the body 110.

In an example, the planar heater 120 may be disposed on an inner side of the body 110 to heat the water received in the interior 101 of the water tank 100.

The planar heater 120 may be provided as a portion of the body 110 and may be formed on a bottom portion of the body 110 to form a lower surface of the interior 101 of the water tank 100.

In an example, the planar heater 120 may be provided as part of the body 110 and disposed on a side surface of the body 110.

In an example, the planar heater 120 may be provided as a bottom plate of the water tank 100.

In an example, the planar heater 120 may be provided as the bottom portion of the body 110.

In an example, the planar heater 120 may form at least a portion of the bottom plate of the water tank 100 and thus form at least a portion of the lower surface of the interior 101 of the water tank 100.

In an example, the planar heater 120 may also be referred to as the bottom plate of the water tank 100 as the planar heater 120 forms the bottom portion of the water tank 100.

In the case where the planar heater 120 is formed on the side surface of the body 110, when the amount of water received in the water tank 100 is reduced, not all of the heat generated by the planar heater 120 may be transferred to the water, resulting in a reduction in the heating (or thermal) efficiency. Accordingly, the planar heater 120 may probably be provided as part of the body 110 and may be formed on the bottom portion of the body 110.

Hereinafter, the planar heater 120 will be described in detail.

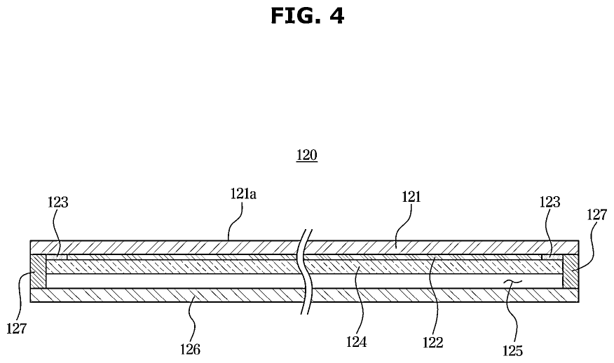

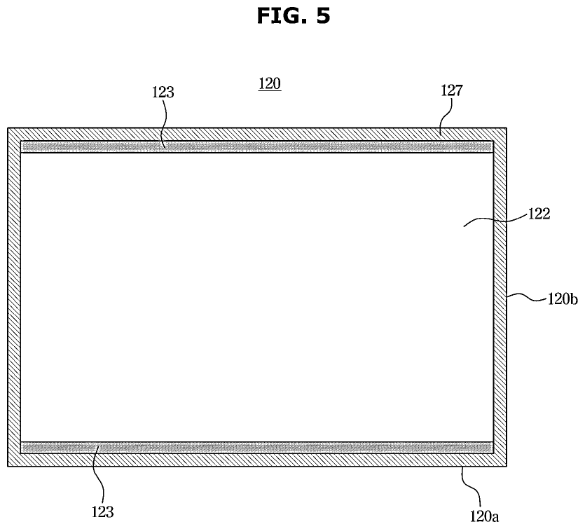

FIG. 4 is a schematic view showing a cross-section of the planar heater of the humidifying apparatus according to an embodiment, and FIG. 5 is a schematic view showing a plane of a partial structure of the planar heater of the humidifying apparatus according to an embodiment.

The planar heater 120 may form the lower surface of the interior 101 of the water tank 100 as part of the body 110.

The planar heater 120 may include a first glass plate 121 forming the lower surface of the interior 101 of the water tank 100. In an example, the first glass plate 121 may form one of an interior surface of the body 110 that forms a region of the interior 101 of the water tank 100.

In an example, the first glass plate 121 may include, in addition to a plate formed of glass, a film or plate formed of a material, such as a colorless polyimide, which may be an alternative to glass.

The first glass plate 121 may be provided in a layer as well as in a plate shape, and thus may be referred to as a first layer.

In the planar heater 120, the first glass plate 121 may be a configuration closest to the interior 101 of the water tank 100. In an example, the first glass plate 121 may be in direct contact with water stored in the interior 101 of the water tank 100.

The first glass plate 121 may include a heating surface 121a to which the heat generated by the planar heater 120 is transferred.

The heating surface 121a may be the lower surface of the interior 101 of the water tank 100. In other words, the heating surface 121a of the first glass plate 121 may be arranged in such a configuration that heat generated by the planar heater 120 is transferred to water received in the interior 101 of the water tank 100 to heat the water, and at the same time may be arranged as the lower surface of the interior 101 of the water tank 100 forming the interior space.

When the water tank 100 is accommodated in the main body 10 in the vertical direction, the heating surface 121a may be arranged at the outermost end of the planar heater 120 and may transfer heat to the water in contact with the heating surface 121a to heat the water contained in the interior 101 of the water tank 100.

The heating surface 121a may be arranged to receive the heat generated by a heating layer 122, which will be described later, and to supply the heat generated thereby to the interior 101 of the water tank 100.

In an example, the first glass plate 121 may be made of a transparent material. In an example, the first glass plate 121 may be configured to include partially glass material, and not all of the first glass plate 121 may be provided as a glass material.

In an example, the first glass plate 121 may be made of a glass material. In an example, the first glass plate 121 may be made of a polyimide film material.

Since the planar heater 120 forms part of the body 110, the planar heater 120 may also be made of a material having a given transparency for the integrity of the body 110 having a given transparency.

The first glass plate 121, as well as the heating layer 122, the electrodes 123, a cover layer 124, and a second glass plate 126, which will be described later, may be made of a material having a given transparency.

In an example, the first glass plate 121 may be provided in a rectangular shape.

The planar heater 120 may include the heating layer 122 disposed on a lower portion of the first glass plate 121 when the water tank 100 is received in the main body 10 in the vertical direction, and arranged to generate heat.

In an example, the heating layer 122 may be provided to be coated the lower portion of the first glass plate 121.

In an example, the heating layer 122 may be formed of a graphene material. In an example, the heating layer 122 may be provided as a graphene thin film layer.

The heating layer 122 may be connected to the power supply portion located outside the heating layer 122 through the electrodes 123, which will be described later, and may be arranged to be heated by an electric current as power is applied.

In an example, the heating layer 122 may be formed of a transparent graphene material.

In an example, the heating layer 122 may be provided in a rectangular shape. In an example, the heating layer 122 may be provided in a rectangular shape with a smaller area than the first glass plate 121.

In an example, the heating layer 122 may be provided as a plurality of graphene thin film layers. In an example, the plurality of graphene thin film layers may be superimposed in the vertical direction when the water tank 100 is received in the main body 10.

With the number of the plurality of graphene thin film layers, a value of the sheet resistance of the heating layer 122 as a whole may be set, and accordingly, a degree of heating of the water received may be set according to the size of the interior 101 of the water tank 100.

In an example, the plurality of graphene thin film layers may be arranged to be stacked two to three in the vertical direction. In an example, the plurality of graphene thin film layers may be arranged to be stacked in 10 or less in the vertical direction Z.

In an example, the planar heater 120 may include the respective electrode 123 that is electrically connected to the heating layer 122.

In an example, the electrodes 123 may be arranged on each of a pair of edges of the heating layer 122 that are arranged in a rectangular shape.

In an example, the electrodes 123 may be arranged to extend along a long side 120a of the heating layer 122 corresponding to the long side 120a of the planar heater 120.

This is to ensure that a distance between the pair of electrodes 123 is short. When the pair of electrodes 123 extends along a short side of the heating layer 122 corresponding to a short side 120b of the planar heater 120, the thermal performance may be reduced because the distance between the pair of electrodes 123 is greater than when the pair of electrodes 123 extends along the long side of the heating layer 122.

In an example, the respective electrode 123 may be formed by patterning. In an example, the respective electrode 123 may be arranged to be patterned on the edge of the heating layer 122. In an example, the electrodes 123 may be arranged by forming a pattern structure on the edges of the heating layer 122 and transferring the electrodes 123 to the patterned structure.

In an example, the electrodes 123 may include a transparent material to have a given transparency. In an example, the electrodes 123 may include a metallic material, such as silver Ag or copper Cu for high conductivity, and a transparent material.

In an example, the electrodes 123 may be provided in a fine-sized pattern so that the electrodes are not visible to the user.

The planar heater 120 may include the cover layer 124 that covers the heating layer 122 at a lower portion of the heating layer 122 in the vertical direction.

The cover layer 124 may prevent the heating layer 122 from being exposed to the outside, thereby preventing the heating layer 122 from being oxidized by contact with outside air and preventing the heating layer 122 from being in contact with the water received in the interior 101 of the water tank 100.

In the vertical direction, an upper surface of the heating layer 122 may be covered by the first glass plate 121, and a lower surface of the heating layer 122 may be covered by the cover layer 124, so that the heating layer 122 is not exposed to the outside.

In the vertical direction, the upper surface of the heating layer 122 may be attached to an lower surface of the first glass plate 121, and the lower surface of the heating layer 122 may be attached to the cover layer 124.

In an example, the cover layer 124 may be made of a material with high heat resistance.

In an example, the cover layer 124 may be made of a polymer material having high air and water tightness.

In an example, the cover layer 124 may include a silicon material. In an example, the cover layer 124 may include an ethylene vinyl acetate (EVA) material.

The planar heater 120 may include the second glass plate 126 formed on a lower end of the planar heater 120 in the vertical direction.

In an example, the second glass plate 126 may include, in addition to a plate formed of glass, a film or plate formed of a material, such as a colorless polyimide, which may be an alternative to glass.

The second glass plate 126 may be provided in a layer as well as in a plate shape, and thus may be referred to as a second layer.

The second glass plate 126 may be disposed to be spaced apart from a lower side of the cover layer 124 in the vertical direction.

The second glass plate 126 may be disposed to be spaced apart from the first glass plate 121 in the vertical direction.

In an example, the second glass plate 126 may be made of a transparent material.

In an example, the second glass plate 126 may be configured to include partially glass material, and not all of the second glass plate 126 may be provided as a glass material.

In an example, the second glass plate 126 may be made of a glass material. In an example, the second glass plate 126 may be made of a polyimide film material.

In an example, the second glass plate 126 may be provided in a rectangular shape. In an example, the second glass plate 126 may be formed with an area approximately corresponding to that of the first glass plate 121. In an example, the second glass plate 126 and the first glass plate 121 may be arranged to be superimposed correspondingly in the vertical direction.

The second glass plate 126 may be arranged to reflect heat transferred from the heating layer 122 to the heating surface 121a.

The heat generated from the heating layer 122 in the vertical direction may be transferred upwardly to the heating surface 121a, and the water stored in the interior 101 of the water tank 101 may be heated through the heat transferred from the heating surface 121a.

In this case, the heat generated by the heating layer 122 may also be transferred to downward to the second glass plate 126 disposed on the lower portion of the planar heater 120, thereby reducing the heating efficiency of the planar heater 120.

To prevent such a situation, the second glass plate 126 may be arranged to reflect the heat transferred from the heating layer 122 to the heating surface 121a, thereby increasing the heating efficiency of the planar heater 120.

The second glass plate 126 may be arranged to guide a movement of heat generated by the heating layer 122 in only one direction of the vertical direction Z, thereby increasing the heating efficiency of the planar heater 120.

In an example, the second glass plate 126 may include a low emissivity layer 126a disposed toward the heating layer 122 to reflect heat toward the heating layer 122.

In an example, the low emissivity layer 126a may be coated on the second glass plate 126 facing the first glass plate 121.

In an example, the second glass plate 126 may include a glass body made of a glass material, and the low emissivity layer 126a may be formed to have a low-emissivity coating having an emissivity of approximately 0.01 to 0.5 on the glass body.

In an example, the low emissivity layer 126a coated with a low-emissivity material may be arranged on an upper surface of the second glass plate 126 in the vertical direction.

Heat transferred from the heating layer 122 to the second glass plate 126 through the low emissivity layer 126a may be reflected back to the heating layer 122 and the heating surface 121a and then transferred to water stored in the interior 101 of the water tank 100 on the heating surface 121a. As a result, a greater amount of heat may be transferred to the water received in the interior 101 of the water tank 100 on the heating surface 121a.

In an example, the low emissivity layer 126a may reflect heat, which is moved in a direction opposite to the direction toward the interior 101 of the water tank 100 of the heat generated by the heating layer 122, toward the interior 101 of the water tank 100, thereby increasing the heating efficiency of the planar heater 120.

The planar heater 120 may include a sealing member 127 disposed between the first glass plate 121 and the second glass plate 126 in the vertical direction.

The sealing member 127 may be configured to seal a gap space between the first glass plate 121 and the second glass plate 126 from the outside.

The sealing member 127 may be configured to seal the heating layer 122 and the cover layer 124 from the outside.

The sealing member 127 may prevent water received in the interior 101 of the water tank 100 from permeating into the planar heater 120 in the front-to-back direction or left-to-right direction, or outside air from entering the planar heater 120.

The sealing member 127 may be arranged to seal the edges of the planar heater 120. In an example, the sealing member 127 may be arranged to seal between the first glass plate 121 and the second glass plate 126 in the front-to-back direction and the left-to-right direction when the water tank 100 is accommodated in the main body 10.

In an example, the sealing member 127 may be arranged to seal the gap space between the first glass plate 121 and the second glass plate 126 along the edges of the first glass plate 121 and the second glass plate 126.

In an example, the sealing member 127 may be formed of a polymeric material with high airtightness and watertightness.

In an example, the sealing member 127 may include an acrylic material or a silicone material.

The planar heater 120 may include the gap space 125 sealed from the outside by the first glass plate 121, the second glass plate 126, and the sealing member 127. More specifically, the gap space 125 may a space formed between the cover layer 124 and the second glass plate 126.

The gap space 125 may be a sealed space formed inside the planar heater 120, which may suppress heat that is moved in a direction towards the second glass plate 126 from the heat generated by the heating layer 122, and may guide the heat to the heating surface 121a, thereby increasing the heating efficiency of the planar heater 120.

In an example, since the first glass plate 121 and the second glass plate 126 are made of glass, when the heating layer 121 continues to generate heat, the first and second glass plates 121 and 126 may be distorted due to thermal deformation. In this case, the gap space 125 may be provided as a space that may buffer the distortion of the first and second glass plates 121 and 126 when the distortion occurs in the first and second glass plates 121 and 126, thereby preventing the planar heater 120 from being damaged.

In an example, the gap space 125 may be provided in a vacuum state. In an example, the gap space 125 may be capable of containing an inert gas.

In an example, the gap space 125 may be arranged to block air from entering the heating layer 122 from the outside. This is to minimize oxidation by oxygen in the air when the heating layer 122 is made of graphene material. Accordingly, the gap space 125 may additionally be configured to contain an inert gas to minimize oxygen entering the heating layer 122.

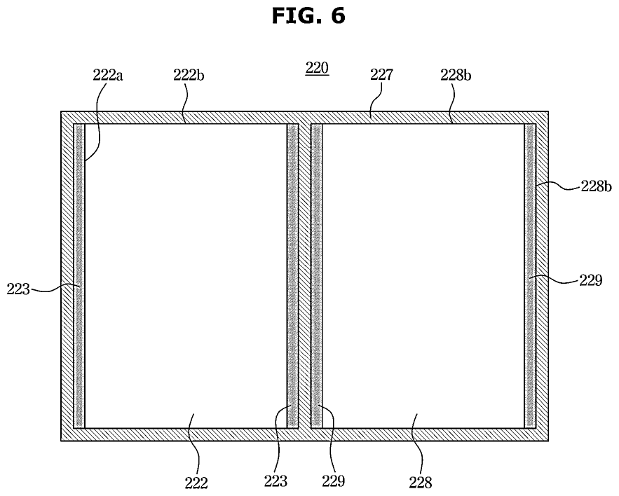

FIG. 6 is a schematic view showing a plane of a partial structure of the planar heater of the humidifying apparatus according to an embodiment.

In an example, as shown in FIG. 6, the planar heater 220 may include a plurality of heating layers 222 and 228. In an example, the plurality of heating layers 222 and 228 may include a first heating layer 222 and a second heating layer 228 disposed on the same plane as the first heating layer 222 in the front-to-back direction or the left-to-right direction when the water tank 100 is received in the main body 10.

In an example, when the volume of the interior 101 of the water tank 100 is increased, the plurality of heating layers 222 and 228 may be disposed on the same plane in the front-to-back direction or the left-to-right direction to increase the area of the planar heater 220 in the front-to-back direction or the left-to-right direction. As a result, the water received in the interior 101 of the water tank 100 may be efficiently heated.

In an example, the first electrode 223 electrically connected to the first heating layer 222 may be arranged in a pair along a long side 222a of the first heating layer 222.

In an example, the pair of first electrodes 223 may be spaced apart from each other by a length of a short side 222b of the first heating layer 222.

In an example, a second electrode 229 electrically connected to the second heating layer 228 may be arranged in a pair along a long side 228a of the second heating layer 228.

In an example, the pair of second electrodes 229 may be spaced apart from each other by a length of the short side 228b of the second heating layer 228.

In an example, the sealing member 227 may be arranged to seal both the edges of the first heating layer 222 and the edges of the second heating layer 228 in the front-to-back direction and the left-to-right direction.

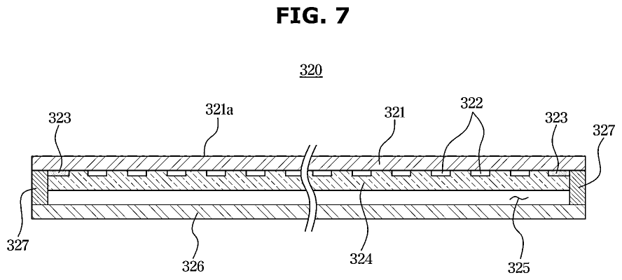

In an example, at least a portion of the sealing member 227 may be disposed between the first heating layer 222 and the second heating layer 228 on the same plane to seal the entire edges of the first heating layer 222 and the second heating layer 228. FIG. 7 is a schematic view showing a cross-section of a lower portion of the water tank of the humidifying apparatus according to an embodiment.

In an example, a heating layer 322 formed of a graphene material may be attached to a lower surface of a first glass plate 321 formed of a glass material, and a cover layer 324 may be attached to a lower surface of the heating layer 322. At this time, if the adhesive force between the heating layer 322 and the cover layer 324 is formed stronger than the adhesive force between the heating layer 322 and the first glass plate 321, delamination may occur between the first glass plate 321 and the heating layer 322, causing a durability problem of a planar heater 320.

In an example, to solve such a problem, as shown in FIG. 7, the heating layer 322 of the planar heater 320 may be patterned on a lower surface of the first glass plate 321.

Accordingly, the patterned heating layer 322 and the electrodes 323 may be arranged on the lower surface of the first glass plate 321, and a region which does not overlap with the heating layer 322 in the vertical direction may be formed by the patterning of the heating layer 322.

In an example, the cover layer 324 may cover the patterned heating layer 322 from a lower side of the heating layer 322. In this case, the cover layer 324 may be arranged to cover all of the regions on the lower surfaces of the heating layer 322 and the first glass plate 321 that do not overlap with the heating layer 322 in the vertical direction.

As the cover layer 324 is attached to the heating layer 322 as well as to the lower surface of the first glass plate 321, the cover layer 324 may support the attachment between the heating layer 322 and the first glass plate 321, thereby improving the durability of the planar heater 320.

The planar heater 320 may include a gap space 325 formed by a second glass plate 326 positioned on a lower side of the cover layer 324 and sealing members 327 positioned on opposite sides of the cover layer 324. Accordingly, although distortion occurs in the first and second glass plates 321 and 326, the gap space 325 may prevent the planar heater 320 from breaking, thereby improving the durability of the planar heater 320.

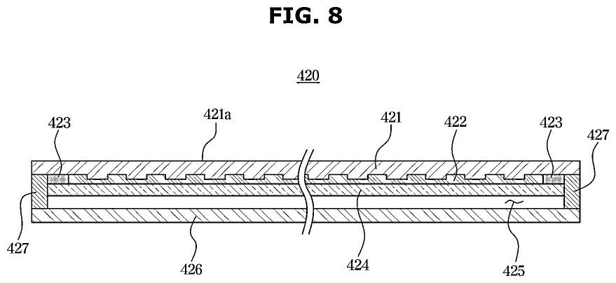

FIG. 8 is a schematic view showing a cross-section of a lower portion of the water tank of the humidifying apparatus according to an embodiment.

In an example, a heating layer 422 formed of a graphene material may be attached to a lower surface of the first glass plate 421 formed of a glass material, and a cover layer 424 may be attached to a lower surface of the heating layer 422. At this time, if the adhesion between the heating layer 422 and the cover layer 424 is formed stronger than the adhesion between the heating layer 422 and the first glass plate 421, delamination may occur between the first glass plate 421 and the heating layer 422, causing a durability problem.

In an example, to solve such a problem, the lower surface of the first glass plate 421 of the planar heater 320 may be patterned as shown in FIG. 8.

A plurality of protrusions may be formed on the lower surface of the first glass plate 421 by patterning, and thus the area of the lower surface of the first glass plate 421 may be increased, thereby increasing the attachment area to the heating layer 422. In an example, as the attachment area of the heating layer 422 and the first glass plate 421 is increased, the adhesion force between the heating layer 422 and the first glass plate 421 is increased, so that the durability of the planar heater 420 may be improved by minimizing delamination of the heating layer 422.

The planar heater 420 may include a gap space 425 formed by a second glass plate 426 positioned on a lower side of the cover layer 424 and sealing members 427 positioned on opposite sides of the cover layer 424. Accordingly, although distortion occurs in the first and second glass plates 421 and 426, the gap space 425 may prevent the planar heater 420 from breaking, thereby improving the durability of the planar heater 420.

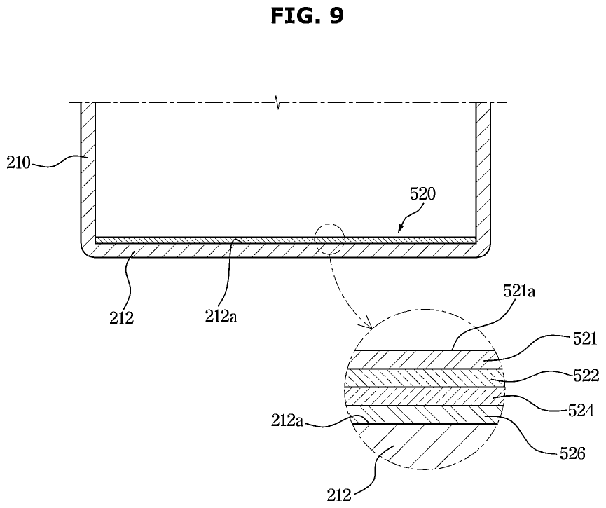

FIG. 9 is a schematic view showing a cross-section of a lower portion of the water tank of the humidifying apparatus according to an embodiment.

In an example, a planar heater 520 may be disposed on a bottom 212 of a body 210 rather than as a portion of the body 210. In an example, the planar heater 520 may be disposed on an upper surface 212a of the bottom 212 of the body 210.

In an example, the planar heater 520 may include a first glass plate 521 including a heating surface 521a, a heating layer 522 disposed on a lower side of the first glass plate 521, a cover layer 523 covering the heating layer 522 on a lower side of the heating layer 522, and a second glass plate 526 disposed on a lower side of the cover layer 523 and forming a lower end of the planar heater 520.

In an example, the heating surface 521a may form a lower surface of an inner space of the water tank formed by the body 210.

In an example, the first glass plate 521 and the second glass plate 526 may be made of a polyimide film material.

In an example, since heat generated by the planar heater 520 may be transferred to the body 210 in contact with the planar heater 520, the body 210 may be made of a material having high heat resistance.

While the present disclosure has been particularly described with reference to exemplary embodiments, it should be understood by those of skilled in the art that various changes in form and details may be made without departing from the spirit and scope of the present disclosure.

1. A humidifying apparatus, comprising:
a water tank; and
a duct through which water vapor generated in the water tank flows, wherein
the water tank includes a bottom plate including a first glass plate disposed within the water tank and a second glass plate disposed below the first glass plate and spaced apart from the first glass plate,
the first glass plate includes a heating layer coated on a lower surface of the first glass plate and configured to generate heat, and
the second glass plate includes a low emissivity layer coated on an upper surface of the second glass plate to suppress heat generated in the heating layer from being transferred to an outside of the second glass plate.

2. The humidifying apparatus of claim 1, wherein the bottom plate further includes a sealing member to seal a space between the first glass plate and the second glass plate from the outside.

3. The humidifying apparatus of claim 2, wherein the bottom plate further includes a gap space formed by the first glass plate, the second glass plate, and the sealing member.

4. The humidifying apparatus of claim 1, wherein the heating layer includes a graphene material.

5. The humidifying apparatus of claim 1, further comprising a cover layer covering the heating layer.

6. The humidifying apparatus of claim 5, wherein the cover layer includes a silicone material.

7. The humidifying apparatus of claim 1 wherein the first glass plate forms a bottom interior surface of the water tank.

8. The humidifying apparatus of claim 2, wherein
the first glass plate further includes at least one electrode electrically connected to the heating layer, and
the at least one electrode is sealed by the sealing member.

9. The humidifying apparatus of claim 8, wherein the at least one electrode includes a first electrode and a second electrode formed at opposite ends of the heating layer, respectively, along a longest side of the heating layer.

10. The humidifying apparatus of claim 3, wherein the gap space contains an inert gas.

11. The humidifying apparatus of claim 1, wherein the first glass plate and the second glass plate each include a polyimide film material.

12. The humidifying apparatus of claim 1, wherein the heating layer is patterned on the lower surface of the first glass plate.

13. The humidifying apparatus of claim 5, wherein the heating layer is patterned on the lower surface of the first glass plate, and the cover layer is configured to cover a region of the lower surface which is exposed by the patterned heating layer.

14. The humidifying apparatus of claim 1, wherein
the lower surface of the first glass plate is patterned, and
the heating layer is attached to an entirety of the patterned lower surface.

15. A humidifying apparatus comprising:
a water tank; and
a duct through which water vapor generated in the water tank flows, wherein
the water tank includes a body, and a planar heater forming a bottom of the body,
the planar heater includes a first glass plate forming at least a portion of a bottom of the water tank and having a heating layer configured to generate heat, a second glass plate disposed below the first glass plate and spaced apart from the first glass plate, and a sealing member configured to seal a space between the first glass plate and the second glass plate from an outside, and
the second glass plate includes a low emissivity layer coated on an upper surface of the second glass plate to suppress heat generated in the heating layer from being transferred to the outside of the second glass plate.

16. The humidifying apparatus of claim 15, wherein the heating layer is coated on a lower surface of the first glass plate.

17. The humidifying apparatus of claim 16, wherein the planar heater further includes a gap space formed by the first glass plate, the second glass plate, and the sealing member.

18. The humidifying apparatus of claim 16, wherein the heating layer includes a graphene material.

19. The humidifying apparatus of claim 16, wherein the first glass plate further includes a cover layer covering the heating layer.

20. A planar heater comprising:
a first glass plate;
a second glass plate disposed below the first glass plate and spaced apart from the first glass plate;
a sealing member to seal a space between the first glass plate and the second glass plate from an outside; and
a gap space formed by the first glass plate, the second glass plate, and the sealing member,
wherein the first glass plate includes a heating layer coated on a lower surface of the first glass plate, and
the second glass plate includes a low emissivity layer coated on an upper surface of the second glass plate to suppress heat generated in the heating layer from being transferred to the outside of the second glass plate.
